(19) United States
(12) Patent Application Publication
(10) Pub. No.: US 2019/0281473 A1
(43) Pub. Date: Sep. 12, 2019

(54) HAPTIC AUGMENTED REALITY ASSISTED SELF-SERVICE FOR WIRELESS NETWORKS

(71) Applicant: Nokia Technologies OY, Espoo (FI)

(72) Inventors: Qi LIAO, Murray Hill, NJ (US); Stefan WESEMANN, Murray Hill, NJ (US); llaria MALANCHINI, Murray Hill, NJ (US); Paolo BARACCA, Murray Hill, NJ (US)

(73) Assignee: Nokia Technologies OY, Espoo (FI)

(21) Appl. No.: 16/347,029

(22) PCT Filed: Jun. 16, 2017
(86) PCT No.: PCT/US17/37833

§ 371 Date: May 2, 2019

(30) Foreign Application Priority Data
Nov. 3, 2016 (EP) 16306439.7

(51) Int. Cl. H04W 16/18; H04L 12/24; G06F 3/0484; G06F 3/0488; H04W 16/28; H04W 24/02; H04W 24/08; H04W 48/16; H04W 48/20; H04W 64/00; G06T 19/00

(52) U.S. Cl. CPC H04W 16/18; H04L 41/22; G06F 3/04845; G06F 3/0488; H04L 41/12; H04W 16/28; H04W 88/08; H04W 24/08; H04W 48/16; H04W 48/20; H04W 64/003; G06T 19/006; H04W 24/02

(57) ABSTRACT

A system, apparatus, method, and non-transitory computer readable medium for haptic augmented reality (AR) based feedback for user-centric wireless network may include a mobile device including a display device configured to display an AR user interface of a user's physical location, a location sensor configured to obtain real-time physical location information related to the mobile device, at least one wireless transceiver configured to determine characteristics of at least one wireless network, a camera configured to obtain at least one image of the user's physical location, a memory having computer readable instructions stored thereon, and at least one processor configured to execute the computer readable instructions to provide haptic AR based feedback for user-centric wireless networks.

### CROSS-REFERENCE TO RELATED APPLICATION

This application claims the benefit of priority to European Patent Application No. 16306439.7, filed on Nov. 3, 2016 with the European Patent Office (EPO), the entire disclosure of which is incorporated herein by reference in its entirety.

### BACKGROUND

### Field

Various example embodiments relate to methods, apparatuses, systems, and/or non-transitory computer readable media for providing haptic augmented reality (AR) based feedback for user-centric wireless networks. More specifically, the example embodiments are related to the use of mobile devices operating in a wireless network environment, including mixed wireless network environments, to design and plan a wireless network, provide feedback regarding the wireless network performance of an existing wireless network, such as providing feedback regarding specific areas of a user's surroundings, and to provide virtual control and/or actual control of the wireless network based on the provided feedback. Additionally, according to some example embodiments, the user may receive functional modules generated by a network server that may configure and/or customize the wireless network environment in accordance with the user's feedback.

### Description of the Related Art

In traditional local and/or private wired and/or wireless networks (e.g., intranets, virtual private networks, etc.), the local network will be owned and/or operated by an entity that does not specialize in network administration and/or employ people capable of designing, configuring and maintaining a complex local network, particularly with regards to new mixed use networks, such as networks designed around emerging technologies (e.g., 5G network and beyond). These entities may be corporations, businesses, organizations, government agencies, universities, schools, an individual person, family, etc. Additionally, some entities may desire building and maintaining a local and/or private network due to security reasons, for example, to minimize the involvement of outside vendors and contractors that have access to the local and/or private network and may steal confidential information from the network, and/or leave backdoors, spyware, malware, etc., on the network. Moreover, there is also a demand for alternatives to having on-site network administrators (e.g., IT personnel, outside contractors, etc.) to reduce the cost of employing the on-site network administrators and/or to enable on-site network administrators to have access to network administrators more knowledgeable regarding new technologies, such as 5G networks, who are located in remote sites.

Accordingly, there is a desire to provide cost savings for local network design, configuration and maintenance support, while also providing user-centric and user-specified privacy controls over the access and information the local network support has access to. Additionally, there is a further desire to provide the local network support over a remote connection (e.g., a remote network administration technical support services) based on instructions from a customer using a visual medium, such as haptic feedback using an augmented reality (AR) based view of the customer's actual environment, in order to simplify and/or increase the efficiency of the network administration process. There is also a desire for a system that provides an easy-to-operate user interface (UI) that allows a customer to specify and set their preferences for network design and operation. Moreover, there is a desire for a system that generates easy-to-use executable network configuration software based on a customer's network design parameters that may be used to configure the customer's network with reduced and/or minimal burden on the customer.

### SUMMARY

At least one example embodiment relates to a mobile device for providing haptic augmented reality (AR) based feedback for user-centric wireless networks.

In at least one example embodiment of the mobile device, the mobile device includes a display device configured to display an AR user interface of a user's physical location, a location sensor configured to obtain real-time physical location information related to the mobile device, at least one wireless transceiver configured to determine characteristics of at least one wireless network, a camera configured to obtain at least one image of the user's physical location, a memory having computer readable instructions stored thereon, and at least one processor configured to execute the computer readable instructions to generate location-based wireless network information based on the determined characteristics of the at least one wireless network and the real-time physical location information, transmit the generated location-based wireless network information and the image of the user's physical location to at least one server, receive from the server a wireless network map associated with the user's physical location, the wireless network map including access point (AP) information, predicted network coverage information, and estimated network status information, display the AR user interface on the display device, the AR user interface based on the received wireless network map, receive user input related to the AR user interface as haptic feedback, the haptic feedback including user instructions regarding the at least one wireless network, transmit the haptic feedback to the at least one server, and receive at least one functional module from the at least one server based on the user instructions.

Some example embodiments of the mobile device include wherein the display device is a touchscreen display, the user input includes a touch input or a gesture input on the touchscreen display, and the haptic feedback includes at least one of: selection of at least one AP of the at least one wireless network to connect the mobile device to, selection of at least one desired network serving area, the selection of the desired network serving area including network serving area control information, desired control information related to the at least one AP, the desired control information including actual control information of the at least one AP or virtual control information of the at least one AP, and relocation instructions related to at least one mobile AP of the at least one wireless network.

Some example embodiments of the mobile device include wherein the desired control information further includes at least one of: information related to a desired location of the at least one AP, a desired direction and shape of a beam of the at least one AP, quality of service (QoS) information to the at least one AP, the QoS information including desired coverage area information associated with the at least one AP, desired network capability information related to the at least one wireless network, desired latency information related to the at least one AP, desired security information related to the at least one AP, and desired network troubleshooting area.

Some example embodiments of the mobile device include wherein the at least one mobile AP includes at least one of: an AP installed on a drone, and an AP installed on a motorized wheeled device.

Some example embodiments of the mobile device include wherein the actual or virtual control information related to the at least one AP includes at least one of: actual or virtual control of a beam of the at least one AP, actual or virtual mechanical control of an antenna of the at least one AP, actual or virtual electrical control of a downtilt angle or azimuth angle of the at least one AP, actual or virtual control of an antenna radiation pattern of the at least one AP, selection of a desired radio technology of the at least one AP, selection of network optimization functions associated with the at least one AP, and modification of access authorization of the at least one AP associated with the server.

Some example embodiments of the mobile device include wherein the wireless network map includes at least one of: information related to a coverage area associated with the at least one wireless network, estimated current load information of the at least one wireless network, estimated beam pattern information of the at least one wireless network, the estimated beam pattern information including estimated orientation of at least one antenna of at least one AP associated with the at least one wireless network, estimated signal strength information of the at least one wireless network, estimated capacity information of the at least one wireless network, and estimated link reliability information of the at least one wireless network.

Some example embodiments of the mobile device include wherein the transmitted information from the mobile device and the at least one server is based on a privacy policy configured by the user.

Some example embodiments of the mobile device include wherein the at least one processor is further configured to modify configuration information related to at least one AP based on the at least one functional module.

At least one example embodiment relates to a server for providing haptic augmented reality (AR) based feedback for user-centric wireless networks.

In at least one example embodiment of the server, the server includes a memory having computer readable instructions stored thereon, and at least one processor configured to execute the computer readable instructions to, receive location-based wireless network information and at least one image of a user's physical location from at least one mobile device, the location-based wireless network information including determined characteristics of at least one wireless network associated with the user, and real-time physical location information associated with the user, generate a wireless network map associated with the user's physical location, the wireless network map including access point (AP) information, predicted network coverage information, and estimated network status information, based on the received location-based wireless network information and the image, receive haptic feedback from the at least one mobile device, the haptic feedback including user instructions regarding the at least one wireless network, generate at least one functional module based on the user instructions, and transmit the at least one functional module to the at least one mobile device.

Some example embodiments of the server include wherein the at least one processor is further configured to generate the wireless network map by: extracting 2D position information related to at least one AP of the at least one wireless network from the image, transforming the 2D position information into 3D position information at least based on objects located in the image, calculating propagation patterns associated with the at least one AP based on the 3D position information and the received location-based wireless network information, and generating the wireless network map based on the 3D position information and the calculated propagation patterns.

Some example embodiments of the server include wherein the at least one functional module includes instructions to modify configuration information related to at least one AP.

Some example embodiments of the server include wherein the haptic feedback includes at least one of: selection of at least one AP of the at least one wireless network to connect the mobile device to, selection of at least one desired network serving area, the selection of the desired network serving area including network serving area control information, desired control information related to the at least one AP, the desired control information including actual control information of the at least one AP or virtual control information of the at least one AP, and relocation instructions related to at least one mobile AP of the at least one wireless network.

Some example embodiments of the server include wherein the desired control information further includes at least one of: information related to a desired location of the at least one AP, a desired direction and shape of a beam of the at least one AP, quality of service (QoS) information to the at least one AP, the QoS information including desired coverage area information associated with the at least one AP, desired network capability information related to the at least one wireless network, desired latency information related to the at least one AP, desired security information related to the at least one AP, and desired network troubleshooting area.

Some example embodiments of the server include wherein the at least one mobile AP includes at least one of: an AP installed on a drone, and an AP installed on a motorized wheeled device.

Some example embodiments of the server include wherein the actual or virtual control information related to the at least one AP includes at leak one of: actual or virtual control of a beam of the at least one AP, actual or virtual mechanical control of an antenna of the at least one AP, actual or virtual electrical control of a downtilt angle or azimuth angle of the at least one AP, actual or virtual control of an antenna radiation pattern of the at least one AP, selection of a desired radio technology of the at least one AP, selection of network optimization functions associated with the at least one AP, and modification of access authorization of the at least one AP associated with the server.

Some example embodiments of the server include wherein the at least one processor is further configured to generate the wireless network map by: calculating at least one of, estimated current load information of the at least one wireless network, estimated beam pattern information of the at least one wireless network, the estimated beam pattern information including estimated orientation of at least one antenna of at least one AP associated with the at least one wireless network, estimated signal strength information of the at least one wireless network, estimated capacity information of the at least one wireless network, and estimated link reliability information of the at least one wireless network, and adding information related to a coverage area associated with the at least one wireless network to the wireless network map.

Some example embodiments of the server include wherein the transmitted information from the mobile device and the at least one server is based on a privacy policy configured by the user.

At least one example embodiment relates to a method for providing haptic augmented reality (AR) based feedback for user-centric wireless networks.

In at least one example embodiment of the method, the method includes obtaining, using at least one processor, real-time physical location information related to a mobile device from a location sensor, determining, using the at least one processor, characteristics of at least one wireless network associated with a user based on at least one wireless transmitter, obtaining, using the at least one processor, at least one image of the user's physical location, generating, using the at least one processor, location-based wireless network information based on the determined characteristics of the at least one wireless network and the real-time physical location information, transmitting, using the at least one processor, the generated location-based wireless network information and the image of the user's physical location to at least one server, receiving, using the at least one processor, from the server a wireless network map of the user's physical location, the wireless network map including access point (AP) information, predicted network coverage information, and estimated network status information, displaying, using the at least one processor, the AR user interface on the display device, the AR user interface based on the received wireless network map, receiving, using the at least one processor, user input related to the AR user interface as haptic feedback, the haptic feedback including user instructions regarding the at least one wireless network, transmitting, using the at least one processor, the haptic feedback to the at least one server, and receiving, using the at least one processor, at least one functional module from the at least one server based on the user instructions.

Some example embodiments of the method include receiving the user input, the user input including a touch input or a gesture input, on a touchscreen display of the mobile device, and wherein the haptic feedback includes at least one of: selection of at least one AP of the at least one wireless network to connect the mobile device to, selection of at least one desired network serving area, the selection of the desired network serving area including network serving area control information, desired control information related to the at least one AP, the desired control information including actual control information of the at least one AP or virtual control information of the at least one AP, and relocation instructions related to at least one mobile AP of the at least one wireless network.

Some example embodiments of the method include modifying, using the at least one processor, configuration information related to at least one AP based on the at least one functional module.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a local/private network support system according to at least one example embodiment;

FIG. 2 illustrates a hardware configuration of a mobile device for providing haptic augmented reality (AR) based feedback for user-centric wireless networks according to at least one example embodiment;

FIG. 3 illustrates a hardware configuration of a server for providing haptic AR based feedback for user-centric wireless networks according to at least one example embodiment;

FIG. 4 illustrates an example augmented reality graphical user interface (GUI) according to at least one example embodiment;

FIG. 5 illustrates an example wireless network map according to at least one example embodiment; and

FIG. 6 is a flowchart illustrating a method for providing haptic augmented reality (AR) based feedback for user-centric wireless networks according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (RUM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Example embodiments are discussed herein as being implemented in a suitable computing environment. Although not required, example embodiments will be described in the general context of computer-executable instructions, such as program modules or functional processes, being executed by one or more computer processors or CPUs. Generally, program modules or functional processes include routines, programs, objects, components, data structures, etc. that perform particular tasks or implement particular data types. The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits, field programmable gate arrays (FPGAs) computers or the like.

At least one example embodiment refers to an augmented reality (AR) based local/private network support system that allows on-site users to provide visual, haptic feedback to remote support personnel while maintaining the user desired privacy controls over the local network.

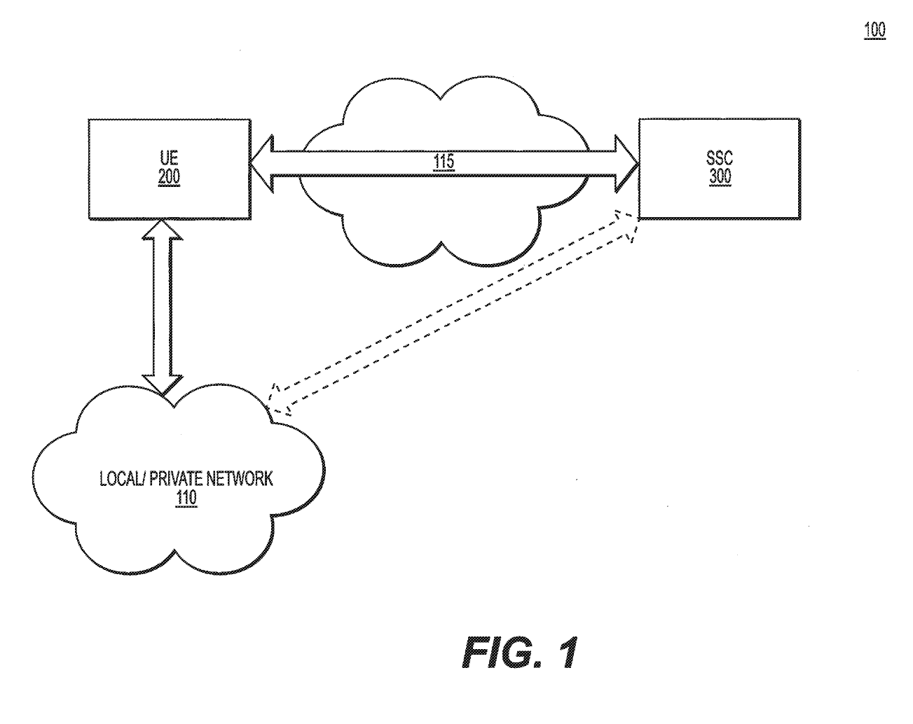

FIG. 1 illustrates a local/private network support system according to at least one example embodiment. As shown in FIG. 1, a local/private network support system 100 includes a local/private network 110, a remote connection 115, at least one user equipment (UE) 200, and a supporting service center (SSC) 300 according to at least one example embodiment. Additionally, the local/private network 110 may further include one or more wired and/or wireless access points (APs) (not shown), wireless base stations (BSs) (not shown), a network gateway (not shown), a local server (not shown), one or more connected network devices (e.g., additional UEs, servers, etc.), etc., that comprise the local and/or private network. The UE 200 and the BSs may be connected over a wired network and/or a wireless network, such as a cellular wireless access network (e.g., a 3G wireless access network, a 4G-Long Term Evolution (LTE) network, a next generation (e.g., 5G) wireless network, etc.), a WiFi network, a WiMAX network, etc. Additionally, the local/private network 110 may include a plurality of wireless network technologies, or in other words, the local/private network 110 may be a mixed network. The wired and/or wireless APs and/or BSs may connect to a network gateway over a wired and/or wireless network. The local/private network 110 may be a network that is owned, operated, setup, supported, etc., by one or more customers, clients, enterprises, etc., that desire remote network technical support for the local/private network 110. The local/private network 110 may be an Intranet, a local area network, a private network, etc., that is not openly accessible to the public. In other words, the local/private network 110 may be a network that allows restricted access and/or allows access to only a desired subset of UEs. Additionally, the local/private network 110 may be a smaller scale network (that may connect to larger networks, such as the Internet) that may or may not be publicly accessible, and may be constrained based on geographic proximity (e.g., a network servicing an office building, a factory, a store, a residence, a campus, a municipality, etc.).

The UE 200 may be any one of, but not limited to, a mobile device, a smartphone, a tablet, a laptop computer, a desktop computer, an AR headset, a virtual reality (VR) headset, and/or any other type of portable or stationary device capable of establishing communication via one or more wired and/or wireless network to the Internet and/or other devices, such as the SSC 300.

The SSC 300 may be at least one server, remote support center, cloud server system, data center, etc., that may provide support for at least one local/private network 110 that is operated by a customer. The SSC 300 performs technical support, such as network modeling, visualization, planning, diagnosing, network anomaly detection, optimization, etc., based on the customer's input in accordance with the customer's privacy control settings. The SSC 300 may connect to the UE 200 over a remote connection 115 via the network gateway that is separate from the local/private network 110. The remote connection 115 may be a secure and/or encrypted connection over a wide area network, such as the Internet. In other words, the SSC 300 may only communicate with the UE 200 via the remote connection 115, and the SSC 300 may not directly connect to and/or access the local/private network 110 unless the UE 200 grants the SSC 300 such permission. Additionally, the remote connection 115 may be subject to privacy configurations set by the customer using the UE 200, including the filtering of information transmitted between the UE 200 and/or the SSC 300, the granting of access to the SSC 300 to connect to the local/private network 110 via a bridging of the remote connection to the local/private network 110 via the UE 200 (and/or through a network gateway, local server, etc.), etc. Additionally, the privacy configurations may include settings set by the operator of the SCC 300 to permit and/or deny access to resources located on the SCC 300 and/or associated with the SCC 300, such as privacy settings regarding the release of functional modules to the UE 200 and/or local/private network 110, the usage of supporting library files by the UE 200 and/or local/private network 110, downloads and/or usage of network tools including network self-planning, self-healing, self-optimization, and/or network anomaly detection, etc.

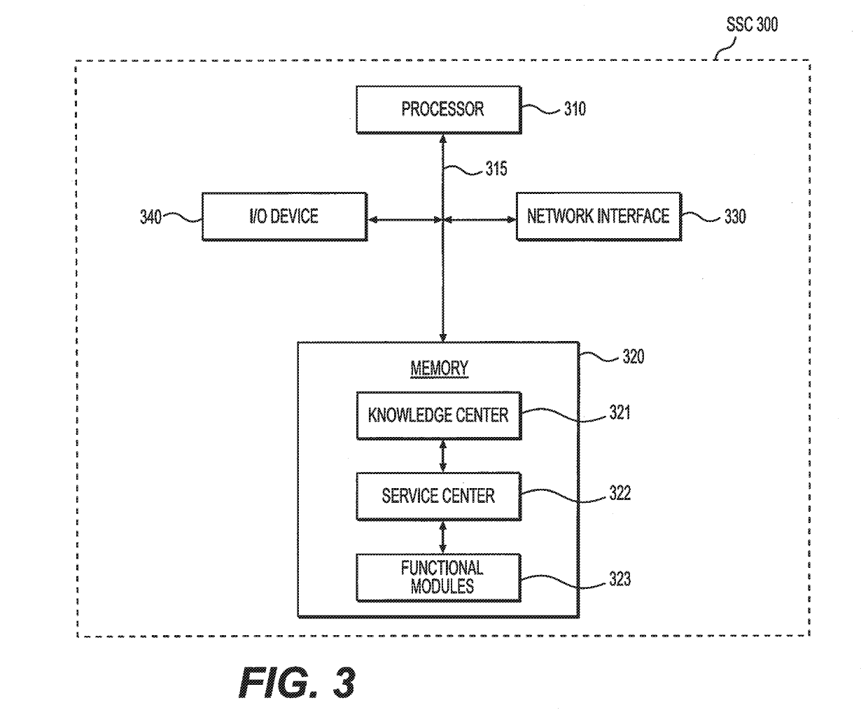

According to some example embodiments, the privacy configuration settings may be stored on the UE 200, the SSC 300, a network gateway, and/or a local server included in the local/private network 110, and based on the privacy configuration settings (e.g., full authorization mode), the SSC 300 may be granted full authorization (and/or virtually control the local/private network 110 and any network equipment and network devices connected to the local/private network 110), or partial authorization (and/or partial virtual control of the local/private network 110 and/or any network equipment and network devices connected to the local/private network 110, etc.) to access the local/private network 110. The SSC 300's access to the local/private network 110 may be controlled/enforced by the UE 200, the network gateway, and/or local server, any of which may act as a “firewall” between the SSC 300 and the local/private network 110. In cases where the SSC 300 is not permitted to directly access the local/private network 110, the SSC 300 may only communicate with the UE 200. The SSC 300 will be discussed in more detail in connection with FIG. 3.

While FIG. 1 only illustrates one UE 200, the number of UEs in the local/private network support system 100 is not limited thereto and may include any number of UEs that are the same or different from the UE 200 described above. Additionally, while FIG. 1 only illustrates one SSC 300, the number of SSCs in the local/private network support system 100 is not limited thereto and may include any number of SSCs that are the same or different from SSC 300.

The local/private network support system 100 further includes one or more local/private network 110, which may in turn include one or more network devices (not shown), such as base stations (BSs), routers, access points (APs), etc. The network devices may operate according to at least one underlying wireless access and/or wired access technology. For example, if the UE 200 is a 5G-enabled device, then the BSs are g-NodeBs (gNB), or other 5G-based cell base stations, however the example embodiments are not limited thereto and the BSs may support one or more of WiFi, WiMAX, Bluetooth, NEC, 4G LTE, 3G, Ethernet, etc.

In at least one example embodiment, the UE 200 may communicate and/or transmit data to and from a network gateway (and/or a local server) via the network devices. The network gateway facilitates the communication of UEs connected to the local/private network 110 with other devices, such as the SSC 300, servers, websites, etc., over a back-end network, such as the Internet, the remote connection 115, etc. Additionally, the network gateway may act as a firewall to control access to the local/private network 110 based on privacy configuration settings, including controlling the SSC 300's direct access to the local/private network 110.

While certain components of the local/private network support system 100 are shown in FIG. 1, the example embodiments are not limited thereto. The local/private network support system 100 may include components other than those shown in FIG. 1, which are necessary and/or beneficial for operation of the underlying networks within the local/private network support system 100, such as the network gateway, a local server, APs, switches, routers, nodes, etc., and may also support additional local/private networks 110, SSCs 300, etc.

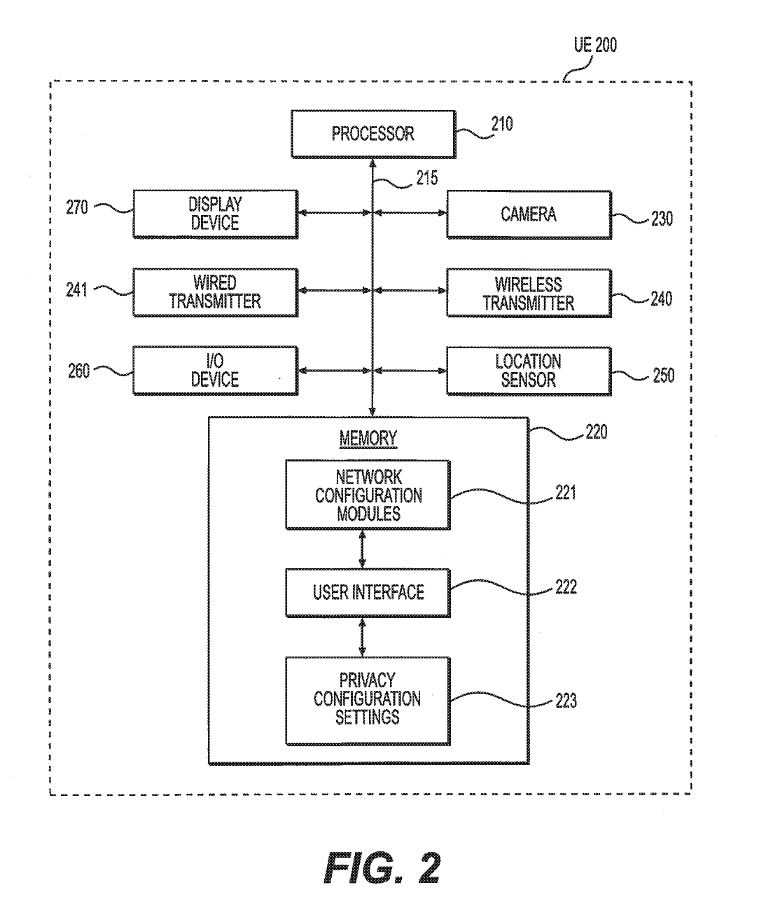

FIG. 2 illustrates a hardware configuration of a mobile device for providing haptic augmented reality (AR) based feedback for user-centric wireless networks according to at least one example embodiment. The mobile device for providing the haptic AR feedback may be a UE, such as UE 200, but is not limited thereto. The UE 200 may include at least one processor 210, a communication bus 215, and a memory 220. The memory 220 may include various program code including computer executable instructions, such as network configuration modules 221, and user interface module 222, privacy configuration settings 223, etc. The UE 200 may also include at least one camera 230, at least one wireless transmitter 240, at least one wired transmitter 241, location sensors 250, input/output (I/O) devices 260, and a display 270, but is not limited thereto.

In at least one example embodiment, the processor 210 may be at least one processor (and/or processor cores, distributed processors, networked processors, etc.), which may be configured to control one or more elements of the UE 200. The processor 210 is configured to execute processes by retrieving program code (e.g., computer readable instructions) and data from the memory 220 to process them, thereby executing control and functions of the entire UE 200. Once the program instructions are loaded into the processor 210, the processor 210 executes the program instructions, thereby transforming the processor 210 into a special purpose processor.

In at least one example embodiment, the memory 220 may be a non-transitory computer-readable storage medium and may include a random access memory (RAM), a read only memory (ROM), and/or a permanent mass storage device such as a disk drive, or a solid state drive. Stored in the memory 220 is program code (i.e., computer readable instructions) for the network configuration modules 221, user interface module 222, and privacy configuration settings 223, as well as program code related to operating the wireless and/or wired transmitters 240 and 241, etc. Additionally, the memory 220 may store additional data (not shown) for use with the stored program code, such as UE operator profile data, network security information, encryption protocols, authentication protocols, remote connection protocols, etc. Such software elements may be loaded from a non-transitory computer-readable storage medium independent of the memory 220, using a drive mechanism (not shown) connected to the UE 200. In other example embodiments, software elements may be loaded onto the memory 220 through the wireless and/or wired transmitter 240 and 241 via a wireless and/or wired communication protocol, such as Ethernet, USB, FireWire, eSATA, ExpressCard, Thunderbolt, WiMAX, Bluetooth, Near-Field Communications (NFC), Infra-Red (IR) communications, RFID communications, 3G, 4G LTE, 5G, etc.

In at least one example embodiment, the communication bus 215 may enable communication and data transmission to be performed between elements of the UE 200. The bus 215 may be implemented using a high-speed serial bus, a parallel bus, and/or any other appropriate communication technology.

The UE 200 may also include a wireless transmitter 240 and/or a wired transmitter 241. The wireless transmitter 240 and/or the wired transmitter 241 may enable the at least one processor 210 to communicate with and/or transfer data to/from the SSC 300, other UEs connected to the local/private network 110, and/or other computing devices (not shown). In at least one example embodiment, the wireless transmitter 240 and/or a wired transmitter 241 may be a computer hardware element for connecting the UE 200 to one or more computer networks (e.g., the Internet, the local/private network 110, an intranet, a Wide Area Network (WAN), a Local Area Network (LAN), a Personal Area Network (PAN), a Cellular Communication Network, a Data Network, etc.) and/or one or more external computing devices (e.g., a PC, a server, a database, a laptop computer, a smartphone, a tablet, other smart devices, an Internet-of-Things (IOT) device, a gaming console, a Personal Digital Assistant (PDA), etc.).

Additionally, the wireless transmitter 240 may be used to determine wireless network characteristics and/or wireless network conditions associated with the local/private network 110. For example, the wireless transmitter 240 may be used to detect the one or more radio technologies being operated by the BSs, APs, etc., of the local/private network 110, the wireless network frequencies associated with the local/private network 110, the received signal strength indicator (RSSI) at various locations of the customer's physical surroundings and/or environment associated with the local/private network 110, signal-to-interference-plus-noise ratio (SINR) and/or interference level readings associated with various locations of the customer's physical surroundings and/or environment, the physical locations of BSs, wireless APs, etc., network capacity, network coverage area, network latency, network security settings, network access availability and/or network load condition, and other network performance indicators.

The wireless transmitter 240 may be used in conjunction with the location sensor 250 in order to determine the network performance indicators of the local/private network 110 to determine the network performance at various locations in the customer's environment. For example, the location sensor 250 may be a geolocation sensor (e.g., GPS sensor, A-GPS sensor, GLONASS sensor, Iridium sensor, etc.), an indoor positioning sensor (e.g., Bluetooth positioning beacon sensor, IR positioning beacon sensors, RF positioning beacon sensors, etc.), RF triangulation sensor (e.g., cellular radio transmitters that may determine a unit's position through BS triangulation, etc.) and/or a relative position sensor (e.g., gyroscopes, accelerometers, altitude sensors, barometers, magnetometers, pressure sensors, etc.), that is able to determine the physical location of the UE 200. When the wireless transmitter 240 is used in conjunction with the location sensor 250, the UE 200 may collect and/or determine the locations of the network devices and network performance of the local/private network 110 by traversing the physical area of the local/private network 110 (e.g., the customer's physical environment, such as an office building, factory, business, campus, residence, etc.).

The location sensor 250 may also be used to generate and/or update a map (e.g., a two-dimensional (2D) map, a three-dimensional (3D) map, and/or a four-dimensional (4D) map, etc.) of the customer's physical surroundings and/or environment using dead-reckoning techniques and/or based on a previously stored map of the customer's physical surroundings and/or environment (e.g., a blueprint of the customer's building, etc.).

The UE 200 may also include a camera 230. The camera 230 may be a 2D camera, a 3D camera, a Time-of-Flight (TOF) camera, etc., and may be used to capture 2D and/or 3D images or videos of the customer's surroundings. The captured images and/or videos may also be used to determine the location information of the network performance indicators and network device information collected by the wireless transmitter 240 and/or may be used to generate a map of the customer's physical surroundings. Additionally, the camera 230 may be used to provide real-time and/or non-real-time images for the AR Graphical User Interface (GUI) of the UE 200.

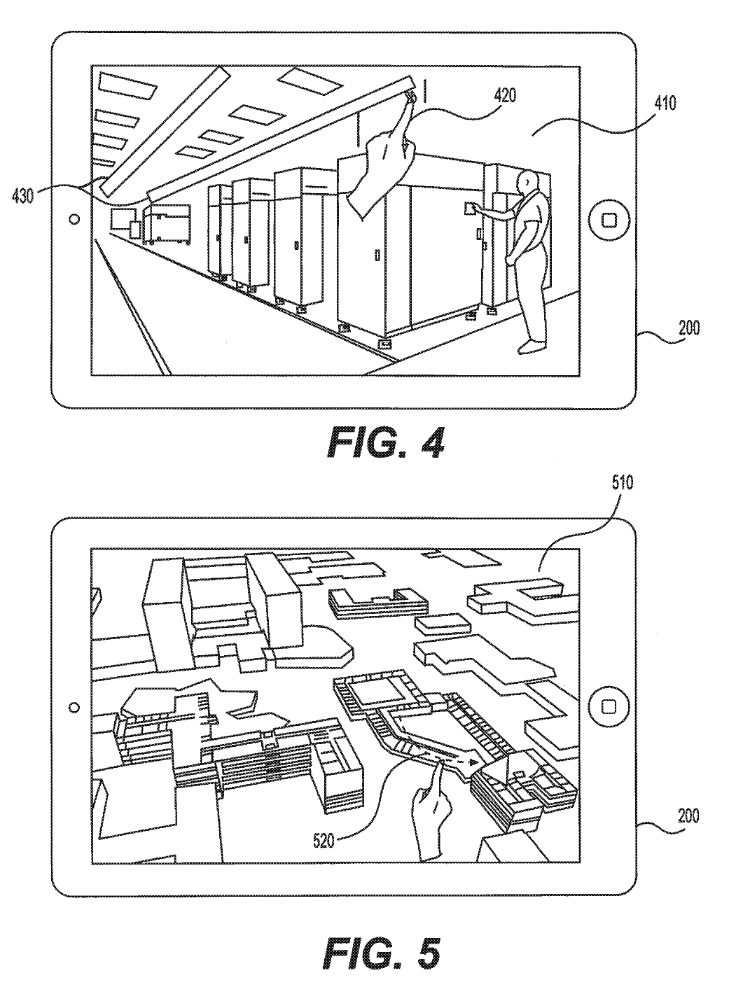

The UE 200 may also include various input/output (I/O) devices 260, such as a keyboard, mouse, touch panel, stylus, microphone, cameras, speakers, haptic feedback devices, etc., which allow an operator to input information and/or data into the AR GUI of the UE 200, and to receive information from the UE 200 and/or SSC 300. For example, the customer may use the touch panel to designate and/or select areas of the customer's environment to configure via the AR GUI. The AR GUI will be discussed in more detail in connection with FIG. 4.

Additionally, the UE 200 may also include a display 270 to provide the AR GUI to the operator of the UE 200 (e.g., the customer, a network support staff, an IT specialist, etc.). For example, the display 270 may be an LED display, a LCD display, a touch panel, a projector, etc., that may provide information related to local/private network 110 and/or the AR GUI to the operator. Additionally, the display 270 may provide instructions to the operator regarding proper network support techniques received from the SSC 300 over the remote connection 115, (e.g., instructions on how to install and/or set up network devices, instructions on how to change software settings, etc.), and may also allow for real-time messaging, teleconferencing and/or videoconferencing between the operator of the UE 200 and remote network support personnel at the SSC 300 using the camera 230 and/or the I/O devices 260.

While FIG. 2 depicts an example embodiment of a UE 200, the UE is not limited thereto, and may include additional and/or alternative architectures that may be suitable for the purposes demonstrated. For example, the UE 200 may include a plurality of additional or alternative elements, such as additional processing devices, sensors, interfaces, and memories, etc.

FIG. 3 illustrates a hardware configuration of a server for providing haptic AR based feedback for user-centric wireless networks according to at least one example embodiment. The server for providing the haptic AR feedback may be a SSC, such as SSC 300, but is not limited thereto. Description of components in the SSC 300 which are the same as components described in connection with FIG. 2 will be partially or completely omitted and the same components may be assumed to have the same and/or similar characteristics and/or operation as the components described in connection with FIG. 2. Differences between the UE 200 and the SSC 300 will be described below.

According to at least one example embodiment, the SSC 300 may include at least one processor 310, a communication bus 315, a memory 320, a network interface 330, and/or I/O devices 340, but is not limited thereto. For example, the SSC 300 may also include a camera for videoconferences, a display device for displaying information provided to the SSC 300 by the UE 200 and/or display information generated by the SSC 300, etc. The memory 320 may include a program code (e.g., computer readable instructions) related to a knowledge center 321, a service center 322, self-executing functional modules 323, etc., but is not limited thereto. The network interface 330 may be a wired and/or wireless transmitter and may be used to connect the SSC 300 with the remote connection 115 over a wired and/or wireless network, such as the Internet, etc.

According to at least one example embodiment, the knowledge center 321 may be a database that stores information regarding various network equipment (e.g., BSs, APs, routers, hardware firewalls, servers, etc.), network devices (e.g., UEs, etc.), operating systems, networking related software, historical network environment measurements, network control parameters and their corresponding network performance measurements, user profiles including network traffic demands, mobility, geographic information, trajectory information, privacy policy agreements between the SSC 300 and the UE 200 and/or local/private network 110, etc., and may be used to assist in the design, installation, configuration, and/or maintenance of the local/private network 110. For example, the knowledge center 321 may include hardware specification information, hardware setting information, etc., associated with the network equipment installed in the local/private network 110. Additionally, the knowledge center 321 may also include similar information regarding other commercially available network equipment that may be used by the SSC 300 to design a new local/private network and/or upgrade the local/private network 110 based on design parameters and/or preferences provided by the customer through the UE 200. The knowledge center 321 may also include information related to network devices connected to the local/private network 110, such as hardware specification information, hardware setting information, operating system information, software setting information, etc., associated with UEs, computers, Internet of Things (IoT) devices, smart devices, network appliances, etc. connected to the local/private network 110. The knowledge center 321 may also include information related to networking software operating on the local/private network 110, such as software firewalls, email (server) applications, VoIP (server) applications, messaging (server) applications, etc., that may be configured based on changes made to the local/private network 110. The knowledge center 321 may also include information regarding commercially available network devices and networking related software in order to facilitate the design and/or upgrade of the local/private network 110 based on design parameters and/or preferences provided by the customer through the UE 200. Additionally, the knowledge center 321 may also store a map of the physical environment of the local/private network 110. The information regarding the local/private network 110 may be transmitted to the SSC 300 by the customer using the UE 200 via the remote connection 115 and/or other communication means. While various examples of information related to the local/private network 110 have been described as stored in the knowledge center 321, the example embodiments are not limited thereto and may include less or more information. For example, various types of information regarding the local/private network 110 may be filtered based on the privacy configuration settings 223 of the UE 200, such as identification of the networking equipment, network devices, networking related software, etc. connected to and/or operating on the local/private network 110.

The memory 320 may also include a service center 322. The service center 322 includes program code (e.g., computer readable instructions) which when executed by the at least one processor 310, transforms the at least one processor 310 into a special purpose processor to provide remote support for the local/private network 110. For example, the service center 322 and the at least one processor 310 (referred herein as service center 322) may use information related to the local/private network 110 received from the UE 200 to generate a wireless network map corresponding to the local/private network 110. The wireless network map may be a 2D, 3D, and/or 4D map of the customer's physical environment, e.g., the customer's office, building, residence, factory, campus, etc., and may include and/or be super-imposed on an architectural rendering (e.g., 2D or 3D blueprint, CAD drawing, etc.) of the physical environment and/or may be based on a building map generated by the location sensors of the UE 200. The wireless network map may be a map of actual network conditions collected by the UE 200, estimated network conditions based on the collected network condition information collected by the UE 200, and/or may be a design model of a wireless network being planned by the user.

The service center 322 may also generate the wireless network map based on one or more 2D images and/or 3D images (or 2D and/or 3D video) captured by the UE 200. The service center 322 may perform image analysis on the image and/or sets of images received from the UE 200 in order to perform a reconstruction of the physical environment based on objects detected in the images. For example, the operator of the UE 200 may be directed (using software installed on the UE 200) to take several images of one or more rooms of the building that the local/private network 110 is installed in with each image including one or more landmark objects, such as a particular network equipment device (e.g., a BS, a wireless AP, a router, etc.), stationary UEs, potential sources of radio interference, points of interest, etc. The service center 322 may then perform a 2D and/or 3D reconstruction of the one or more rooms using the images based on a comparative analysis of the locations and sizes of landmark objects located in the images. The service center 322 may also use location sensor readings captured by the UE 200 at the time that the images were taken and transmitted along with the images (e.g., as metadata or the like) to the SCC 300, in combination with the image analysis in order to perform the 2D and/or 3D reconstruction of the physical environment of the local/private network 110. However, the example embodiments are not limited thereto, and the wireless network map may be generated using alternate techniques.

Additionally, the wireless network map may be a static map (e.g., a conventional map) and/or a dynamic map compatible with an AR display, such as the display of the UE 200. If the wireless network map is a dynamic map, the wireless network map will be encoded with position information corresponding to the physical locations represented by the wireless network map. Moreover, the wireless network map may include information related to the wireless network equipment and/or wireless network performance indicators observed at the various locations illustrated by the wireless network map. For example, the wireless network map may include indicators illustrating the location of various network equipment and/or network devices associated with the local/private network 110, as well as configuration information related to the network equipment and/or network devices (e.g., model name/number, serial number, radio technology used, frequencies used, physical area serviced by the network equipment, etc.). Additionally, the wireless network map may also include network performance information (e.g., estimated radio coverage, estimated signal strength, estimated network capacity, estimated network bandwidth, estimated latency, etc.) related to the local/private network 110 as well.

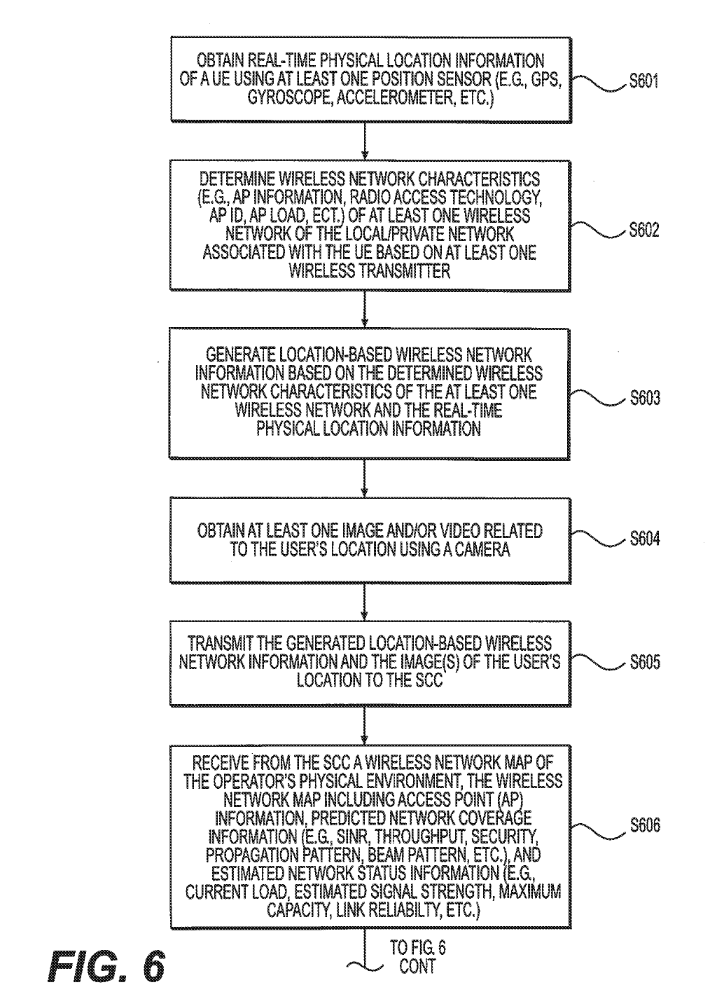

The service center 322 may generate the network performance information based on the actual network performance information collected by the UE 200 (e.g., actual latency, actual bandwidth, actual signal strength, actual beam direction, actual radio interference levels, etc.) at the various locations of the physical environment, and/or may generate estimates of the network performance (e.g., estimated coverage area, estimated network capacity, estimated network bandwidth, estimated latency, estimated radio interference, etc.) by calculating the propagation patterns associated with the network serving areas of the BSs and APs of the local/private network 110. For example, the propagation patterns may be calculated by performing ray tracing on the collected actual network information to generate a model of the local/private network 110 (e.g., wired and/or wireless networks associated with the local/private network), but the example embodiments are not limited thereto. Additionally, the performance information may be obtained by applying the inference/estimation/prediction, etc., models as a priori knowledge stored in the network knowledge center. The wireless network map may be generated as a function of time (e.g., generated as a 4D wireless network map), wherein the actual and/or estimated network information may change as a function of time. Once the wireless network map is generated by the SCC 300, the SCC 300 may transmit the wireless network map to the UE 200 via the network interface 330 and the remote connection 115. The wireless network map will be discussed in greater detail in connection with FIG. 5.

According to some example embodiments, the memory 320 may also include functional modules 323. The functional modules 323 may be generated by the SCC 300 using the at least one processor 310 based on user information (e.g., haptic feedback) related to the wireless network map received from the UE 200. The haptic feedback may be feedback regarding various network settings that the user may desire to add, modify, upgrade, remove, etc., using the wireless network map. For example, the operator of the UE 200 may provide haptic feedback indicating that the location of a BS is to be changed, the network coverage in a desired room in the physical environment be upgraded, the radio technology used by a selected BS is to be modified, the UE 200 be allowed to connect to a selected BS, etc. Once the haptic feedback is received by the SCC 300, the at least one processor 310 may generate one or more functional modules (e.g., executable software libraries, software packages, scripts, network configuration software, etc.) based on the received haptic feedback and the information related to the network equipment, network devices, network related software, etc., associated with the local/private network 110 stored in the knowledge center 321. Additionally, according to some example embodiments, the functional modules 323 may be pre-generated (e.g., pre-generated to perform popular operations based on particular hardware and/or software combinations, etc. and stored in the memory 320.

Based on the privacy configuration settings, and more specifically, based on whether the SCC 300 is granted authority to virtually control the local/private network 110 and/or the UE 200 will exercise actual control over the local/private network 110, the functional modules may be executed by the SCC 300 and/or the UE 200. According to some example embodiments, when the UE 200 exercises actual control over the local/private network 110 (e.g., the UE 200 directly controls the local/private network 110), the processor 310 of the SCC 300 may select and transmit the appropriate functional module 32.3 to the UE 200. Once the UE 200 receives the functional module 323, the UE 200 may execute the functional module 323, which causes the UE 200 to perform the requested functionality. Thus, the SCC 300 may provide easy-to-use executable network configuration software to the operator of the UE 200. Additionally, when the SCC 300 is granted virtual control over one or more elements of the local/private network 110, the processor 310 of the SCC 300 may execute the appropriate functional module 323 and thereby virtually control the one or more elements of the local/private network 110.

However, based on the privacy configuration settings 223 of the UE 200, the SCC 300 may be prohibited from transmitting an executable functional module 323 to the UE 200, and instead the SCC 300 may transmit written, verbal, and/or video communications to the UE 200 that provides instructions to the operator of the UE 200 on how to make the desired changes to the local/private network 110. According to at least one example embodiment, the written, verbal, and/or video communications transmitted by the SCC 300 to the UE 200 may be provided as AR feedback to the user of the UE 200 (e.g., displayed on the UE 200's AR display) to allow the user to freely roam the physical environment of the local/private network 110 will performing the instructions provided by the SCC 300.

While FIG. 3 depicts an example embodiment of the SCC 300, the SCC 300 is not limited thereto, and may include additional and/or alternative architectures that may be suitable for the purposes demonstrated. For example, the SCC 300 may include a plurality of additional or alternative elements, such as additional processing devices, interfaces, and memories. Additionally, the SCC 300 may be a distributed and/or cloud computing system and may comprise a plurality of interconnected servers configured to serve a plurality of UEs 200.

FIG. 4 illustrates an example augmented reality graphical user interface according to at least one example embodiment. According to at least one example embodiment, a customer may operate the UE 200 to view a real-time image of the customer's environment (e.g., an office, a building, a factory, a residence, a campus, etc.) through an AR GUI. When the camera 230 of the UE 200 is directed towards one or more desired locations of the customer's environment, such as a server room 410, the customer may use the touch panel of the UE 200 in order to provide haptic feedback related to the local/private network 110 using the AR GUI view of the customer's environment. For example, the user may enter a haptic feedback input 420, such as a touch operation, a gesture operation, a mouse input, a keyboard input, a voice input, etc., using the display device 270 (e.g., a touch panel, LED display, etc.) and/or an I/O device 260, in order to select a desired location of the environment, select a desired network equipment, select a desired network device, indicate a desired network command to be performed, etc. For example, the customer may perform a drag gesture operation 430 to select a desired AP and then indicate a preferred location for the AP deployment by dragging the AP to the desired deployment location. However, the example embodiments are not limited thereto and the haptic feedback may use any other haptic feedback type to indicate the desired action of the customer. Additionally, in the design stage of the local/private network 110, the customer may select various locations in the physical environment where the customer desires to place various network equipment, network devices, etc., which is then transmitted to the SSC 300 for visualization and/or network performance analysis using the generated wireless network map. As another example, the customer may also select various locations in the physical environment to specify their respective quality of service (QoS) requirements for the selected physical locations, the network equipment and/or the network devices located in the selected locations, etc.

According to at least one example embodiment, the desired network command may be an instruction to connect to a selected BS or AP, move a mobile AP (e.g., a drone with an AP installed, a motorized AP that travels along rails or tracks, or a motorized AP with wheels, etc.), redirect the beams of an AP, change the frequencies used by an AP, change the radio technology used by an AP or BS, electrically control a downtilt angle and/or azimuth angle of an antenna of an AP or BS, control the radiation pattern of the AP or BS, select a desired network optimization function to be performed by a selected AP or BS, modify the access authority of an AP, designate a quality of service (QoS) level of a desired location, indicate a trouble spot (e.g., a poor wireless performance location) for further network analysis, etc. The desired network command may be a request for actual or virtual control of the selected network equipment and/or the network device.

While various commands and operations have been discussed in connection with FIG. 4, the example embodiments are not limited thereto and other network related commands and operations may be used.

FIG. 5 illustrates an example wireless network map according to at least one example embodiment. In FIG. 5, according to at least one example embodiment, the SCC 300 may generate a wireless network map 510 based on wireless network information provided by the UE 200. The wireless network map 510 may include a map of the physical layout, structures, network equipment, network devices, etc., associated with the customer's environment and/or local/private network 110. The wireless network map may be a 2D, 3D, and/or 4D representation of the customer's environment and local/private network 110. The wireless network map 510 may also include information related to the local/private network 110, such as the locations of network equipment, network devices, wireless coverage areas, indications of radio interference, actual network performance information, estimated network performance information, security information related to the local/private network 110, QoS information, etc. For example, the wireless network map 510 may include information related to one or more APs or BSs installed on the local/private network 110 (e.g., model, type, serial number, frequencies used, radio technologies used, software version number, current load, coverage area, beam pattern, signal strength, antenna orientation, maximum capacity, latency, link reliability, etc.), but the example embodiments are not limited thereto.

Additionally, according to some example embodiments, the customer may use the wireless network map 510 as a second AR GUI view and enter a haptic feedback input 520, e.g., a touch operation, a gesture operation, a mouse input, a keyboard input, a voice input, etc., using the UE 200, to select a desired location of the environment, select a desired network equipment, select a desired network device, indicate a desired network command to be performed, etc. For example, the customer may indicate a desired change in deployment of an AP or BS using the wireless network map 510, which may then be transmitted back to the SCC 300 in order to regenerate the wireless coverage map for the local/private network 110. Accordingly, the customer may be able to self-design, self-configure, and/or self-maintain their local/private network 110 with an easy-to-use and easy to understand AR GUI while limiting the amount of information and/or ensuring the security of the local/private network 110 based on the customer's privacy settings.

While various commands and operations have been discussed in connection with FIG. 5, the example embodiments are not limited thereto and other network related commands and operations may be used.

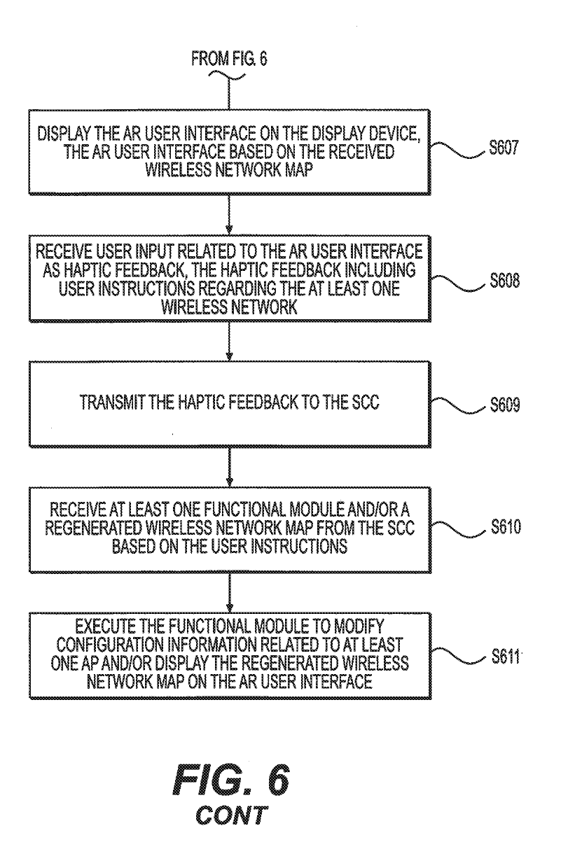

FIG. 6 is a flowchart illustrating a method for providing haptic augmented reality (AR) based feedback for user-centric wireless networks according to at least one example embodiment. As shown in FIG. 6, at operation S601, a UE, such as UE 200, obtains real-time physical location information of the UE (and the operator of the UE) using at least one location/position sensor, such as a GPS sensor, a positioning beacon sensor, a gyroscope, an accelerometer, etc. Next, in operation S602, the UE determines wireless network characteristics of at least one wireless network that are included in the local/private network 110 by collecting information regarding the wireless network(s) using a wireless transmitter. The wireless network characteristics may include information such as BS or AP information, radio access technology, BS or AP ID, BS or AP load, radio frequencies used, signal strength, radio interference, etc. At S603, the UE generates location-based wireless network information by associating the wireless network characteristics with the determined location information of the UE at the time that the wireless network characteristic information was collected. The operations S601, S602, and S603 may occur simultaneously, and/or may occur individually.

At operation S604, the UE obtains at least one image and/or video using a camera of the UE's surrounding environment. The operator of the UE may traverse (and/or be instructed to traverse) the operator's physical environment (e.g., a building, an office, a factory, a residence, a campus, etc.) and may obtain images and/or video of various one or more rooms, landmarks, points of interest, network equipment locations, desired network equipment locations, areas of poor network performance, etc., associated with the physical environment and/or the local/private network. Additionally, the generated location-based wireless network information may be included in the obtained image data and/or video data based on the time-stamp information and/or the location information. According to at least one example embodiment, the UE's obtained real-time physical location information may be associated with a corresponding image and/or video frame, for example, as metadata, by the UE, and/or the real-time physical location information may be transmitted to a SCC, such as SCC 300, for association with the obtained image data and/or obtained video data. Further, the UE may associate the obtained wireless network characteristics with the corresponding obtained image and/or video frame as metadata, and/or the SCC may associate the obtained wireless network characteristics with the corresponding image data and/or video data. The UE and/or the SCC may perform the association based on time-stamp information of the obtained image data, location information, and wireless characteristics information, or the sets of information may be simultaneously obtained.

At S605, the UE transmits the location-based wireless network information and/or the image data/video data to the SCC. At S606, the UE receives a wireless network map of the operator's physical environment that is generated by the SCC based on the information transmitted by the UE in S605. The wireless network map may include the obtained wireless network information, as well as calculated, estimated, and/or predicted wireless network information based on data collected by the UE, such as estimated current network coverage area, optimized network configurations including predicted coverage area if the optimizations are enacted, etc.

At S607, the UE displays the received wireless network map using the AR GUI. Once the wireless network map is displayed, at operation S608, the operator may input user selections and/or user instructions to the AR interface related to the wireless network map as haptic feedback. At S609, the UE transmits the haptic feedback to the SCC.

At S610, the UE receives at least one functional module generated by the SCC based on the operator's haptic feedback. For example, if the haptic feedback related to the operator's desire to connect to a selected AP, the generated functional module may be executable code that causes the UE to connect to the selected AP. As another example, the functional module may be updated configuration settings for a selected network device that, when uploaded by the UE to the selected network device, optimizes the configurations (e.g., radio frequency used, radio technology used, antenna orientation change, change to beam shape, etc.) for the network device based on the operator's haptic feedback. According to at least one example embodiment, the SCC may transmit a regenerated wireless network map that includes modifications to the previously transmitted wireless network map based on the operator's haptic feedback. The SCC may transmit the regenerated wireless network map by itself, or in addition to the functional module.

At S611, the UE may execute the received functional module in order to perform the operator's desired instructions and/or may display the regenerated wireless network map using the AR GUI.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A mobile device for providing haptic augmented reality (AR) based feedback for user-centric wireless networks, the mobile device comprising:
a display device configured to display an AR user interface of a user's physical location,
a location sensor configured to obtain real-time physical location information related to the mobile device;
at least one wireless transceiver configured to determine characteristics of at least one wireless network;
a camera configured to obtain at least one image of the user's physical location;
a memory having computer readable instructions stored thereon; and
at least one processor configured to execute the computer readable instructions to,
generate location-based wireless network information based on the determined characteristics of the at least one wireless network and the real-time physical location information,
transmit the generated location-based wireless network information and the image of the user's physical location to at least one server,
receive from the server a wireless network map associated with the user's physical location, the wireless network map including access point (AP) information, predicted network coverage information, and estimated network status information,
display the AR user interface on the display device, the AR user interface based on the received wireless network map,
receive user input related to the AR user interface as haptic feedback, the haptic feedback including user instructions regarding the at least one wireless network,
transmit the haptic feedback to the at least one server, and
receive at least one functional module from the at least one server based on the user instructions.

2. The mobile device of claim 1, wherein
the display device is a touchscreen display;
the user input includes a touch input or a gesture input on the touchscreen display; and
the haptic feedback includes at least one of,
selection of at least one AP of the at least one wireless network to connect the mobile device to,
selection of at least one desired network serving area, the selection of the desired network serving area including network serving area control information, desired control information related to the at least one AP, the desired control information including actual control information of the at least one AP or virtual control information of the at least one AP, and
relocation instructions related to at least one mobile AP of the at least one wireless network.

3. The mobile device of claim 2, wherein the desired control information further includes at least one of:
information related to a desired location of the at least one AP;
a desired direction and shape of a beam of the at least one AP;
quality of service (QoS) information to the at least one AP,
the QoS information including desired coverage area information associated with the at least one AP;
desired network capability information related to the at least one wireless network;
desired latency information related to the at least one AP;
desired security information related to the at least one AP; and
desired network troubleshooting area.

4. The mobile device of claim 2, wherein the at least one mobile AP includes at least one of:
an AP installed on a drone, and
an AP installed on a motorized wheeled device.

5. The mobile device of claim 2, wherein the actual or virtual control information related to the at least one AP includes at least one of:
actual or virtual control of a beam of the at least one AP;
actual or virtual mechanical control of an antenna of the at least one AP;
actual or virtual electrical control of a downtilt angle or azimuth angle of the at least one AP;
actual or virtual control of an antenna radiation pattern of the at least one AP;
selection of a desired radio technology of the at least one AP;
selection of network optimization functions associated with the at least one AP;
and
modification of access authorization of the at least one AP associated with the server.

6. The mobile device of claim 1, wherein the wireless network map includes at least one of:
information related to a coverage area associated with the at least one wireless network;
estimated current load information of the at least one wireless network;
estimated beam pattern information of the at least one wireless network, the estimated beam pattern information including estimated orientation of at least one antenna of at least one AP associated with the at least one wireless network;
estimated signal strength information of the at least one wireless network;
estimated capacity information of the at least one wireless network; and
estimated link reliability information of the at least one wireless network.

7. The mobile device of claim 1, wherein the transmitted information from the mobile device and the at least one server is based on a privacy policy configured by the user.

8. The mobile device of claim 1, wherein the at least one processor is further configured to:
modify configuration information related to at least one AP based on the at least one functional module.

9. A server for providing haptic augmented reality (AR) based feedback for user-centric wireless networks, the server comprising:
a memory having computer readable instructions stored thereon; and
at least one processor configured to execute the computer readable instructions to,
receive location-based wireless network information and at least one image of a user's physical location from at least one mobile device, the location-based wireless network information including determined characteristics of at least one wireless network associated with the user, and real-time physical location information associated with the user,
generate a wireless network map associated with the user's physical location, the wireless network map including access point (AP) information, predicted network coverage information, and estimated network status information, based on the received location-based wireless network information and the image,
receive haptic feedback from the at least one mobile device, the haptic feedback including user instructions regarding the at least one wireless network,
generate at least one functional module based on the user instructions,
and
transmit the at least one functional module to the at least one mobile device.

10. The server of claim 9, wherein the at least one processor is further configured to generate the wireless network map by:
extracting 2D position information related to at least one AP of the at least one wireless network from the image;
transforming the 2D position information into 3D position information at least based on objects located in the image;
calculating propagation patterns associated with the at least one AP based on the 3D position information and the received location -based wireless network information; and
generating the wireless network map based on the 3D position information and the calculated propagation patterns.

11. The server of claim 9, wherein the at least one functional module includes instructions to modify configuration information related to at least one AP.

12. The server of claim 9, wherein the haptic feedback includes at least one of:
selection of at least one AP of the at least one wireless network to connect the mobile device to;
selection of at least one desired network serving area, the selection of the desired network serving area including network serving area control information;
desired control information related to the at least one AP, the desired control information including actual control information of the at least one AP or virtual control information of the at least one AP; and
relocation instructions related to at least one mobile AP of the at least one wireless network.

13. The server of claim 9, wherein the desired control information further includes at least one of:
information related to a desired location of the at least one AP;
a desired direction and shape of a beam of the at least one AP;
quality of sendee (QoS) information to the at least one AP, the QoS information including desired coverage area information associated with the at least one AP;
desired network capability information related to the at least one wireless network;
desired latency information related to the at least one AP;
desired security information related to the at least one AP; and
desired network troubleshooting area.

14. The server of claim 12, wherein the at least one mobile AP includes at least one of:
an AP installed on a drone, and
an AP installed on a motorized wheeled device.

15. The server of claim 12, wherein the actual or virtual control information related to the at least one AP includes at least one of:
actual or virtual control of a beam of the at least one AP;
actual or virtual mechanical control of an antenna of the at least one AP;
actual or virtual electrical control of a downtilt angle or azimuth angle of the at least one AP;
actual or virtual control of an antenna radiation pattern of the at least one AP;
selection of a desired radio technology of the at least one AP;
selection of network optimization functions associated with the at least one AP; and
modification of access authorization of the at least one AP associated with the server.

16. The server of claim 9, wherein the at least one processor is further configured to generate the wireless network map by:
calculating at least one of,
estimated current load information of the at least one wireless network,
estimated beam pattern information of the at least one wireless network,
the estimated beam pattern information including estimated orientation of at least one antenna of at least one AP associated with the at least one wireless network,
estimated signal strength information of the at least one wireless network,
estimated capacity information of the at least one wireless network, and
estimated link reliability information of the at least one wireless network;
and
adding information related to a coverage area associated with the at least one wireless network to the wireless network map.

17. The server of claim 9, wherein the transmitted information from the mobile device and the at least one server is based on a privacy policy configured by the user.

18. A method for providing haptic augmented reality (AR) based feedback for user-centric wireless networks, the method comprising:
obtaining, using at least one processor, real-time physical location information related to a mobile device from a location sensor;
determining, using the at least one processor, characteristics of at least one wireless network associated with a user based on at least one wireless transmitter;
obtaining, using the at least one processor, at least one image of the user's physical location;
generating, using the at least one processor, location-based wireless network information based on the determined characteristics of the at least one wireless network and the real-time physical location information;
transmitting, using the at least one processor, the generated location -based wireless network information and the image of the user's physical location to at least one server;
receiving, using the at least one processor, from the server a wireless network map of the user's physical location, the wireless network map including access point (AP) information, predicted network coverage information, and estimated network status information;
displaying, using the at least one processor, the AR user interface on the display device, the AR user interface based on the received wireless network map; receiving, using the at least one processor, user input related to the AR user interface as haptic feedback, the haptic feedback including user instructions regarding the at least one wireless network;
transmitting, using the at least one processor, the haptic feedback to the at least one server; and
receiving, using the at least one processor, at least one functional module from the at least one server based on the user instructions.

19. The method of claim 18, the method further comprising:
receiving the user input, the user input including a touch input or a gesture input, on a touchscreen display of the mobile device; and
wherein the haptic feedback includes at least one of,
selection of at least one AP of the at least one wireless network to connect the mobile device to,
selection of at least one desired network serving area, the selection of the desired network serving area including network serving area control information,
desired control information related to the at least one AP, the desired control information including actual control information of the at least one AP or virtual control information of the at least one AP, and
relocation instructions related to at least one mobile AP of the at least one wireless network.

20. The method of claim 18, the method further comprising:
modifying, using the at least one processor, configuration information related to one AP based on the at least one functional module.
